(19) United States
(12) Patent Application Publication
(10) Pub. No.: US 2017/0030754 A1
(43) Pub. Date: Feb. 2, 2017

(54) DOSING APPARATUS

(71) Applicant: WAMGROUP S.P.A., Modena (IT)

(72) Inventor: VAINER MARCHESINI, SAN PROSPERO (IT)

(21) Appl. No.: 15/216,429

(22) Filed: Jul. 21, 2016

(30) Foreign Application Priority Data
Jul. 28, 2015 (IT) 202015000038926

(51) Int. Cl. G01F 13/00; B65D 88/68

(52) U.S. Cl. CPC G01F 13/005; B65D 88/68

(57) ABSTRACT

A dosing apparatus (1) for dosing powdery, granular or flaked substances, comprises:
a containment chamber (30) for receiving said substance;
an homogenizing device (20) arranged internally of the containment chamber (30) and rotatable about an axis (Y) for homogenizing said substance;
a dosing device (10) rotatable about a further axis (X) for conveying metered quantities of said substance outwardly the containment chamber (30);
positioning means (50) for positioning the dosing apparatus (1) with respect to a support structure in an operative configuration.

Said further axis (X) is offset with respect to said axis (Y), so that, in said operative configuration, a vertical plane (P) containing said axis (Y) is passing outside of the dosing device (10).

The invention relates to a dosing apparatus for dosing powdery, granular or flaked substances.

The invention particularly relates to a dosing apparatus intended for dispensing, in a continuous or discontinuous manner, metered quantities of bulk products in the solid and dry state, i.e. not pasty nor emulsified.

The dosing apparatus for powdery, granular or flaked according to the invention is particularly suitable for being used in the chemical industry as well as in the livestock, pharmaceutical or food industry. Uses of the dosing apparatus according to the invention other than those mentioned above may be also provided.

The dosing apparatuses of the known type comprise a containment compartment for containing powdery, granular or flaked substances. Two devices are arranged internally of the containment compartment i.e. an homogenizing device and a dosing device. The homogenizing device prepares the substance and makes it uniform, whilst the dosing device calibrates the amount of substance coming out of the dosing apparatus according to a predetermined operation scheme established by this apparatus. The known dosing apparatuses described above are defined single screw, as they are provided with only one dosing device, or metering screw.

The homogenizing device is arranged in the vicinity of a feeding mouth, wherefrom the powdery, granular or flaked substance derives. It comprises a support rod rotatable about its own longitudinal axis and provided with a plurality of vanes for mixing and/or aerating the powdery, granular or flaked substance. The dosing device is instead disposed downstream the homogenizing device and is configured for dispensing the powdery, granular or flaked substance in a dosed manner.

The dosing device, which is also rotatable about its own longitudinal axis, may comprise a shaft on which a helix is wound. During the rotation, the dosing device acts as a calibrated screw feeder in which at each revolution of the shaft a precise substance quantity corresponds that is dispensed at the outlet of the dosing apparatus.

During operation, the single-screw dosing apparatuses of the known type are positioned in such a way that a vertical plane which contains the longitudinal axis of the homogenizing device, also contains the longitudinal axis of the dosing device, In other words, the homogenizing device and the dosing device extend along respective axes which lie on a common vertical plane.

A drawback of known dosing apparatuses is that the powdery, granular or flaked substance tends to accumulate above the dosing device, thus forming bridge-shaped structures which may extend along the entire length of the containment compartment. This goes to the detriment of homogenization uniformity, affects proper dosage of the outcoming substance and may give rise to contamination or deterioration of those products, such as food products, that need to be dosed based on precise timescales.

In this context, the technical task of the present invention is to make available an apparatus for dosing powdery, granular or flaked substances which overcomes the above mentioned drawbacks as well as any use restrictions that may result therefrom.

It is an object of the present invention to make available a dosing apparatus for dosing powdery, granular or flaked substances, which is effective and allows to perform homogenisation and dosage of a powdery, granular or flaked substances in a repeatable and reliable manner.

These and other objects are substantially attained by a dosing apparatus for powdery, granular or flaked substances according to what is disclosed in one or more of the appended claims.

The dependent claims correspond to further embodiments of a dosing apparatus for powdery, granular or flaked substances in accordance with the present invention.

Further characteristics and advantages will become more apparent from the detailed description of a preferred and non-exclusive embodiment of a dosing apparatus for dosing powdery, granular or flaked substances.

Such description is provided with reference to the accompanying figures, also being illustrated as a non-limiting example wherein:

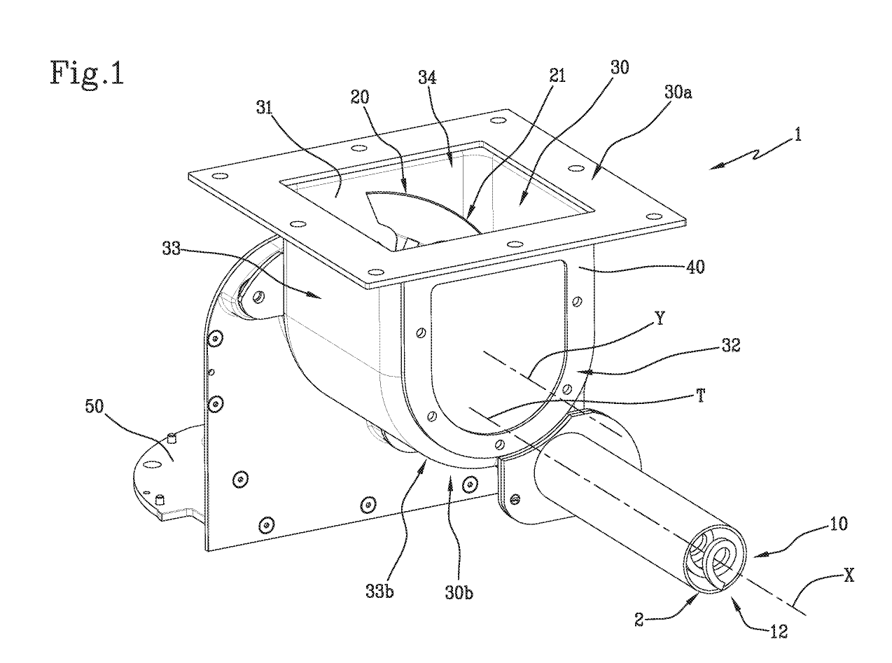

FIG. 1 is a front perspective view showing an apparatus for dosing powdery, granular or flaked substances;

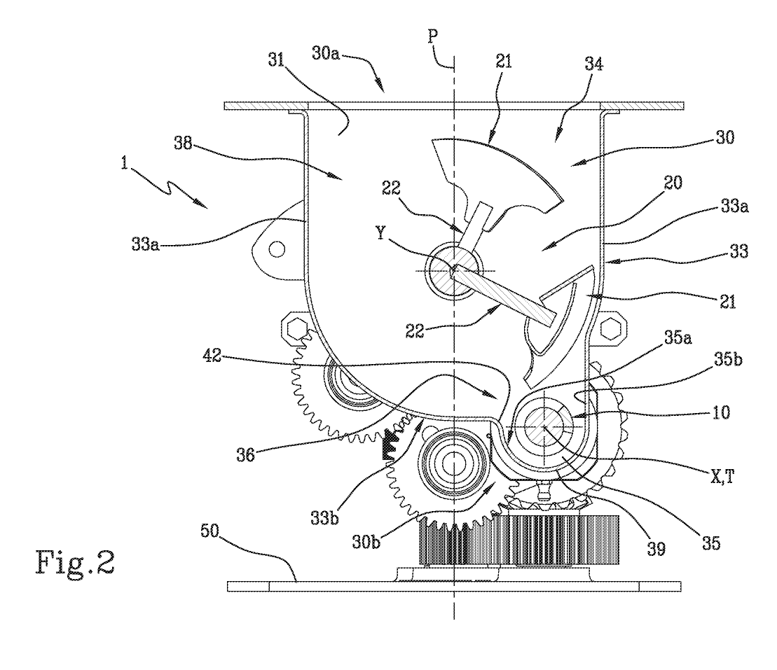

FIG. 2 is a view in section of the dosing apparatus of FIG. 1, taken along a vertical plane perpendicular to a pair of axes of respective devices of the dosing apparatus, and in which some parts have been removed for the sake of clarity of representation;

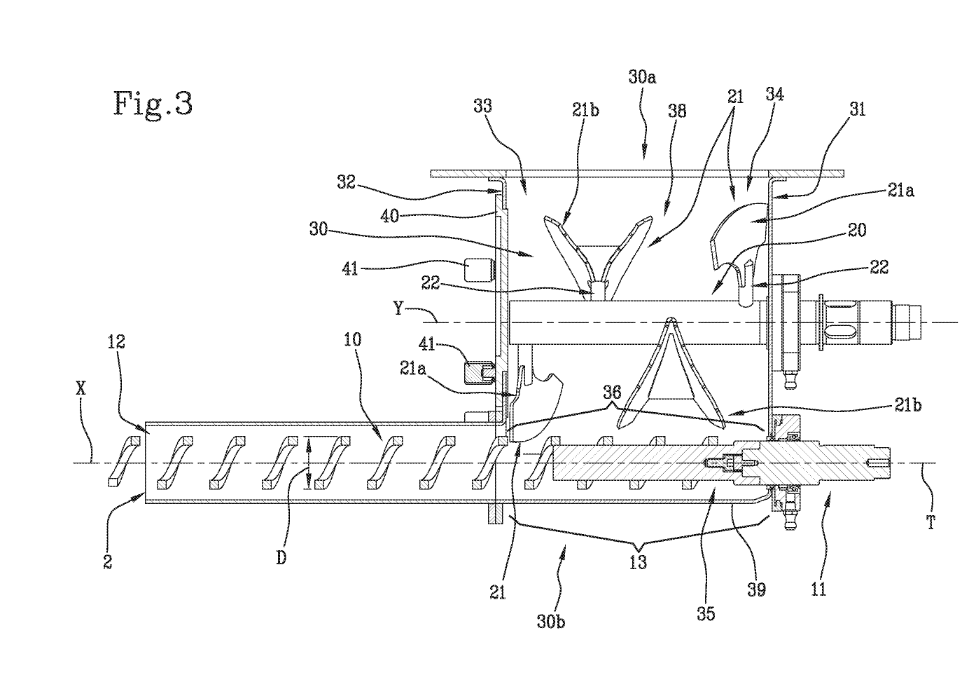

FIG. 3 is a further view in section of the dosing apparatus of FIG. 1 taken along a vertical plane parallel to the axes of the devices of the dosing apparatus, from which some parts have been removed for the sake of clarity of representation;

With reference to FIGS. 1 to 3, by the numeral 1 it is illustrated an apparatus for dosing powderey, granular or flaked substances, in accordance with the present invention. The dosing apparatus 1 allows to dose powdery, granular or flaked substances with a relatively high accuracy and is for this reason referred to by the skilled in the art also with the term “Micro-Batch-Feeder”.

The dosing apparatus 1 comprises a dosing device 10 and an homogenizing device 20, as schematically illustrated for example in FIG. 1.

The homogenizing device 20 and the dosing device 10 are operatively associated with one another in an operating configuration of the dosing apparatus 1. In particular, the homogenizing device 20 is rotatable about an axis of rotation “Y”.

The dosing device 10 is rotatable about a further axis of rotation “X” and extends along this axis. The dosing device 10 has a first end 11 and a second end 12.

Preferably, the axis of rotation “X” of the dosing device 10 is parallel to the axis of rotation “Y” of the homogenizing device 20.

The dosing apparatus 1 comprises a containment chamber 30 delimited by a first end wall 31 and a second end wall 32 facing each other and arranged transversely, in particular perpendicularly, with respect to the axis of rotation “Y” of the homogenizing device 20. The second end wall 32 may be at least partially defined by a port 40, which can be removed for example thanks to the fastening means 41 visible in FIG. 3. By acting on the fastening means 41, the port 40 can be disassembled, so as to enable an operator to perform cleaning, maintenance and/or control operations on the apparatus 1. The port 40 may comprise a transparent portion, so as to make visible to the operator of the apparatus, the interior of the dosing apparatus 1, without the need of having to remove the port 40.

The containment chamber 30 is further delimited by a side junction surface 33 that extends between the first end wall 31 and the second end wall 32 along a direction of development “T” parallel to the axis of rotation “X.

The containment chamber 30 exhibits rounded edges, so as to make the surface of this chamber as far as possible devoid of sharp edges or stagnation corners generated by the powdery, granular or flaked substance. This makes more efficient the emptying of the containment chamber 30 and allows to attain an improved cleaning of the dosing apparatus 1, both because it is more difficult that stagnations arising from the substance to be dosed are formed outside the dosing apparatus 1, and because the dosing apparatus 1 can be easily washed, in particular with water, without having the washing water stagnating in the proximity of the sharp edges of the dosing apparatus 1.

Preferably, the containment chamber 30 exhibits its own upper portion 30a, a feeding mouth 34 which is connectable, for example by means of a flanged portion, to a feeder or a hopper (not shown) for the transport of powdery, granular or flaked substances, within the dosing apparatus 1. The containment chamber 30 further exhibits a lower portion 30b, at which the powdery, granular or flaked substances deposit in an operative configuration of the dosing apparatus 1.

Preferably, as shown in FIG. 2, the side surface 33 of the containment chamber 30 comprises two facing sections 33a, which in the example depicted are substantially vertical and arranged on opposite sides of the axis of rotation “Y”. Between the facing sections 33a, a rounded portion 33b is interposed, which extends as an extension downwards of one of the facing sections 33a, The rounded portion 33b develops at least partially about the axis of rotation “Y” of the homogenizing device 20, so as to delimit, at least partly, the lower portion 30b of the containment chamber 30. In the example shown, the rounded portion 33b is shaped about the axis of rotation “Y” and exhibits a constant radius of curvature relative to said axis.

In a version not shown, the rounded portion 33b may exhibit, in a cross section taken along a plane perpendicular to the axis of rotation “Y”, a non-constant radius of curvature. In the latter case, the rounded portion 33b can be defined by a plurality of curvilinear portions shaped in such a way as to progressively come closer to the homogenizing device 20, by passing from the upper portion 30a to the lower portion 30b.

In other words, the rounded portion 33b may be shaped in such a way as to exhibit a greater distance from the homogenizing device 20 in the area where this portion extends along a direction close to the vertical direction, and instead to exhibit a lesser distance from the homogenizing device 20 in the area where the rounded portion 33b extends along a substantially horizontal direction. In this way, any stagnation of the processed substance is prevented.

The homogenizing device 20 is installed on the dosing apparatus 1 in an intermediate region of the containment chamber 30, as better described hereinafter. In particular, the homogenizing device 20 is arranged so as to occupy a main portion 38 of the containment chamber 30.

The containment chamber 30 further exhibits a housing 35 for housing, at least partially, the dosing device 10. The housing 35 develops starting from the first end wall 31 until the second end wall 32 along the development direction “T”.

In the example shown, the housing 35 is afforded internally of a protuberance 39 that is protruding from the rounded portion 33b of the side surface 33. It is however, also possible to consider a case where the containment chamber 30 is delimited by walls having a thickness such that the housing 35 can be obtained within the thickness of such walls. In this case, it is not possible to identify any protuberance 39 projecting outwardly.

The housing 35 is configured so as to house the dosing apparatus 10. A passage space 36, shown in FIGS. 2 and 3, connects the main portion 38 of the containment chamber 30 with the housing 35, so that the powdery, granular or flaked substance, after interacting with the homogenizing device 20, can pass into the housing 35 through the passage space 36, in order to interact with the dosing device 10. Preferably, the passage space 36 extends along the development direction “T” for a set length.

In particular, the passage space 36 extends along the development direction “T” for a length equal to the distance that exists between the first end wall 31 and the second end wall 32 of the containment chamber 30. The housing 35 is disposed in the vicinity of the rounded portion 33b of the side surface 33. More in detail, the housing 35 and the rounded portion 33b are interposed between the facing sections 33a of the side surface 33. Between the rounded portion 33b and the housing 35 there is provided a connecting zone 42 which is so shaped as to promote the sliding of the powdery, granular or flaked substance from the rounded portion 33b towards the housing 35. In particular, the connecting portion 42 is devoid of sharp edges.

The first end 11 of the dosing device 10 is disposed at the first wall 31 of the containment chamber 30.

As shown in FIG. 3, the dosing device 10 comprises an extraction length 13 that is defined starting from the first end 11, up to a portion of the dosing device 10 being arranged at the second end wall 32 of the containment chamber 30. The second end wall 32 is the wall disposed in the vicinity of an outlet mouth 2 of the dosing apparatus 1, or in any case it is the end wall nearest to the outlet 2 of the dosing apparatus 1.

The outlet mouth 2 is substantially an opening from which the powdery, granular or flaked substance is coming out after interacting with the homogenizing device 20 and with the dosing device 10.

In the example depicted, the extraction portion 13 of the dosing device 10 is facing the passage space 36 of the containment chamber 30. The passage space 36 has, along a direction transversal to the development direction 7″, a proportionate width to a measure of an outer diameter ID″ of the dosing device 10.

The dosing apparatus 1 comprises positioning means 50, shown in FIGS. 1 and 2, to position the dosing apparatus 1 with respect to a support structure, in an operative configuration, i.e. during operation of the apparatus 1. The positioning means 50 may include support means for supporting the dosing apparatus 1 on the support structure, as shown in the example depicted, in which the positioning means 50 are conformed as a base that is projecting from a rear portion of the dosing apparatus 1. However, the positioning means 50 may also be shaped differently from what is shown in the figures. For example, the positioning means 50 may comprise fastening means for fastening the dosing apparatus 1 to the support structure, particularly shaped as a fixing flange.

The housing 35 protrudes downwardly from the lower portion 30b of the containment chamber 30.

The housing 35, and the dosing device 10 arranged internally thereof, is disposed in a lateral position with respect to the axis of rotation “Y” of the homogenizing device 20. In other words, as shown in the appended FIG. 2, in an operative configuration of the dosing apparatus 1, the dosing device 10 is disposed laterally with respect to a vertical plane containing the axis of rotation “Y” of the homogenizing device 20. In an operative configuration of the dosing apparatus 1, a vertical plane P (the trace of which is shown in FIG. 2) that contains the axis of rotation “Y” of the homogenizing device 20, does not intersect the dosing device 10, i.e. it is passing outside the dosing device 10. The vertical plane P is further passing outside the housing 35, as well as outside the protuberance 39. the vertical plane P intersects the rounded portion 33b of the containment chamber 30. The housing 35 is projecting from the rounded portion 33b of the containment chamber 30.

The housing 35 is delimited by an inner curved surface 35a, with respect to the containment chamber 30, that is adapted to fit together at least partially with a respective portion of the dosing device 10.

By the term internal curved surface 35a it is meant a surface portion arranged internally of the housing 35, which is facing the containment chamber 30, that is to say, it is in direct contact with the powdery/granular/flaked substance in an operative configuration of the dosing apparatus 1. Preferably, the curved surface 35a has a radius of curvature approximately equal to the outer diameter “D” of the dosing device 10.

The housing 35 is also delimited by a flat surface 35b which, in the operative configuration of the dosing apparatus 1, is arranged substantially vertically. The flat surface 35b extends tangentially from the curved surface 35a up to a portion of the side surface 33 of the containment chamber 30, as shown schematically in FIG. 2.

Preferably, the flat surface 35b is incident to a portion of the side surface 33 and acts as a connection wall between the housing 35 and the side surface 33 of the containment chamber 30.

The homogenizing device 20 is provided with a plurality of mixing or aeration vanes 21 of fixed on an attachment portion 22 of the homogenizing device 20.

The plurality of vanes 21 may comprise two end vanes 21a disposed in proximity of the first end wall 31 and respectively of the second end wall 32 of the containment chamber 30. The end vanes 21a exhibit a relatively simple shape, and can be substantially flat and arranged obliquely with respect to the axis of rotation “Y”. The end vanes 21a have the function to converge the powdery, granular or flaked substance to be dosed towards a central region of the containment chamber 30.

The plurality of mixing vanes 21 may further comprise a plurality of vanes in the form of a ploughshare 21b, Preferably, the vanes in the form of a ploughshare 21b are interposed between the end vanes 21a. The walls which delimit the containment chamber 30 can be made entirely of metal, or entirely of plastic material, or still can be provided with a plastic material coating.

To the walls of the containment chamber 30, if made of a plastic material, one or more facilitators devices can be associated, for facilitating the descent of the product, for example vibrators or oscillators of the electric or pneumatic type, or they may be associated to mechanical vanes, for causing the walls of the containment chamber 30 to vibrate and help the processed substance to flow towards the outlet, or more precisely towards the dosing device 10. The facilitators devices facilitating the descent of the product can be applied on the outside of the walls of the containment chamber 30 or integrated at least partially within the thickness of these walls.

The apparatus dosing device 1 allows to substantially reduce the accumulation of the substance to be dosed above the dosing device 10, compared with known dosing apparatuses. In fact, by moving laterally the dosing device 10 relative to the homogenizing device 20, the powdery, granular or flaked substance can more easily be conducted towards the outlet mouth 2 while rotating the dosing apparatus 10.

This effect is amplified by the flat surface 35b of the housing 35. In fact, the powdery, granular or flaked substance which is transported upwards during rotation of the dosing apparatus 10, is not able to adhere to the flat surface 35b, which is disposed substantially vertically, but rather tends to slide downwards, thereby detaching from the flat surface 35b. Thus, in this way, the powdery, granular or flaked substance interacts again with the dosing device 10, which transports the latter towards the outlet mouth 2. In the example described with reference to FIGS. 1 to 3, it is always referred to a dosing apparatus 1 which can be termed “single screw”, as it is provided with a single dosing device 10, or of a single dosing screw. The dosing apparatus according to the invention can however also be of the “twin-screw” type, i.e. provided with two dosing devices 10 arranged for dosing of powdery, granular or flaked substance which has been previously processed by a single homogenizing device 20. In this case, a housing 35 is preferably provided which is configured to house the two corresponding dosing devices. The dosing devices are counter-rotating to one another. In an operative configuration of this dosing apparatus, a vertical plane passing through the axis of rotation “Y” of the homogenizing device 20, is lying outside the housing 35. This plan does not intersect the dosing devices.

The two dosing devices of the twin-screw apparatus are interconnected and self-cleaning. They can be separated by a small insert of a substantially triangular section, designed to fill a void space present between the homogenizing devices, below the latter.

Furthermore, the present invention has achieved the intended aims by making available a more efficient dosing apparatus, which is able to accurately carry out a homogenization and dosing process of a bulk substance, repeatable at every operating regime of the same.

In addition, the present invention provides a dosing apparatus capable of homogenizing the bulk substance contained internally thereof, without any accumulations, thus preventing formation of aggregations and residues arising from the processed substance, thereby ensuring high dosing accuracy and ease of cleaning.

1. A dosing apparatus (1) for dosing a powdery, granular or flaked substance comprising:
a containment chamber (30) for receiving said substance;
an homogenizing device (20) arranged internally of the containment chamber (30) and rotatable about an axis (Y) to homogenize said substance;
a dosing device (10) rotatable about a further axis (X) for conveying metered quantities of said substance out of the containment chamber (30);
positioning means (50) for positioning the dosing apparatus (1) with respect to a support structure in an operative configuration;
characterized in that said further axis (X) is offset with respect to said axis (Y), so that, in said operative configuration, a vertical plane (P) containing said axis (Y) is passing outside of the dosing device (10).

2. A dosing apparatus (1) according to claim 1, in which the dosing device (10) is disposed inside a housing (35) that communicates with a main portion (38) of the containment chamber (30), wherein the homogenizing device (20) is arranged, said vertical plane (P) passing outside the housing (35), in the operative configuration.

3. A dosing apparatus (1) according to claim 2, wherein said housing (35) is internally delimited by a curved surface (35a) partially surrounding the dosing device (10), and by a flat surface (35b) which connects said curve surface (35a) with the main portion (38) of the containment chamber (30), said flat surface (35b) being arranged substantially vertically in the operative configuration.

4. A dosing apparatus (1) according to claim 2, wherein the housing (35) is formed internally of a protuberance (39) which is protruding from a lower region (30b) of the containment chamber (30).

5. A dosing apparatus according to claim 2, wherein the housing (35) communicates with the main portion (38) of the containment chamber (30) via a passage space (36) through which said substance may flow.

6. A dosing apparatus (1) according to claim 1, in which the containment chamber (30) is defined by a first end wall (31) and a second end wall (32), facing each other and arranged transversely with respect to said axis (Y), the containment chamber (30) being further defined by a side surface (33) that connects said first end wall (31) and said second end wall (32).

7. A dosing apparatus (1) according to claim 5, in which the containment chamber (30) is defined by a first end wall (31) and a second end wall (32), facing each other and arranged transversely with respect to said axis (Y), the containment chamber (30) being further defined by a side surface (33) that connects said first end wall (31) and said second end wall (32), and in which the passage space (36) is extending from the first end wall (31) to the second end wall (32),

8. A dosing apparatus (1) according to claim 6, wherein the side surface (33) of the containment chamber (30) comprises a rounded portion (33b) extending at least partially about said axis (Y) and having a curvilinear profile.

9. A dosing apparatus (1) according to claim 8, wherein, in the operative configuration, said vertical plane (P) intersects the rounded portion (33b).

10. A dosing apparatus (1) according to claim 2, in which the containment chamber (30) is defined by a first end wall (31) and a second end wall (32), facing each other and arranged transversely with respect to said axis (Y), the containment chamber (30) being further defined by a side surface (33) that connects said first end wall (31) and said second end wall (32), wherein the side surface (33) of the containment chamber (30) comprises a rounded portion (33b) extending at least partially about said axis (Y) and having a curvilinear profile, and wherein said housing (35) is protruding from the rounded portion (33b) of the containment chamber (30).

11. A dosing apparatus (1) according to claim 1, in which said homogenizing device (20) is provided with two end regions in each of which an end vane (21a), is disposed, and the end vanes (21a) being shaped for conveying the substance in a central zone of the containment chamber (30).

12. A dosing apparatus (1) according to claim 1, in which a single dosing device is provided (10).

13. A dosing apparatus (1) according to claim 1, and further comprising an additional dosing device co-operating with said dosing device (10) for conveying metered quantities of said substance out of the containment chamber (30).

14. A dosing apparatus (1) according to claim 13, wherein said further dosing device is rotatable about a corresponding offset axis with respect to said axis (Y) so that, in the operative configuration, said vertical plane (P) is passing outside of said dosing device (10) and of said further dosing device.

15. A dosing apparatus (1) according to claim 1, having a body at least partially made of a plastic material.

16. A dosing apparatus (1) according to claim 1, and further comprising at least one descent facilitator device for facilitating the descent of said substance into the containment chamber (30).
